(19) United States
(12) Patent Application Publication
(10) Pub. No.: US 2022/0061260 A1
(43) Pub. Date: Mar. 3, 2022

(54) SYSTEM AND METHOD FOR DIRECTING LIVESTOCK ANIMAL

(71) Applicant: Yehonatan GROSS, Ein Gev (IL)

(72) Inventor: Yehonatan GROSS, Ein Gev (IL)

(21) Appl. No.: 17/415,243

(22) PCT Filed: Dec. 17, 2019
(86) PCT No.: PCT/IL2019/051376

§ 371 Date: Jun. 17, 2021

Related U.S. Application Data
(60) Provisional application No. 62/780,519, filed on Dec. 17, 2018.

(51) Int. Cl. A01K 1/00; A01K 11/00

(52) U.S. Cl. CPC A01K 1/0023; A01K 1/12; A01K 11/006

(57) ABSTRACT

A method and a system configured to differentially direct the passage of livestock animal; to signal the livestock animal; to identify an individual livestock animal and to monitor livestock activity are provided.

### TECHNICAL FIELD OF THE INVENTION

The present invention generally relates to a system and a method of directing livestock. More particularly, the present invention relates to systems and methods for directing livestock using signals.

### BACKGROUND OF THE INVENTION

Modern days livestock farming requires managing large groups of animals, monitoring each animal, monitoring the herd, groups of animals within the herd, the conditions in the farm and the like.

About 30% of livestock farming costs are related to the cost of food. In order to increase efficiency, livestock farmers monitor the amount and type of food consumed by the entire herd and compare it to the production of the herd. Currently, in commercial farms there are no known ways to monitor the feeding of each individual animal, even though the productivity of each animal (e.g., the production of milk, wool, meet, etc.) is known.

Another aspect in livestock farming is the need to sort and direct individual animals or groups of animals from a first place to a second place. Modern livestock farms include automatic gating systems that typically include a corridor leading to an automated gate. The automated gate may be configured to open upon the arrival of the animal, by an automatic opening mechanism. Such gates suffer a variety of disadvantages: they are normally heavy, very expensive and scare the animals in their proximity when opened and closed.

This requires farmers to forcefully direct the animals into the corridor leading to the gate. Furthermore, such management of livestock, including forceful separation between members in the herd tends to have a disruptive effect on the atmosphere and wellbeing of the herd

Accordingly, there is a need for a new sorting and directing system that may allow simple sorting of livestock, without scaring the animals and at a much lower cost than the commercial systems that are in use today. Such a new system may further allow collecting data related to the feeding behavior of each animal in the herd and may thus allow better determination of food efficiency.

### BRIEF DESCRIPTION OF THE DRAWINGS

FIG. 1 is an illustration, depicting an exemplary embodiment of a system for directing livestock of the invention;

FIG. 2 is an illustration, depicting an exemplary embodiment of a system for directing livestock of the invention;

FIG. 3 is an illustration, depicting an exemplary embodiment of a system for directing livestock of the invention;

FIG. 4 shows a block diagram of an exemplary embodiment of a controller, that may be included in a system for directing livestock;

FIG. 5 is a flowchart depicting an exemplary embodiment of a method of directing livestock;

FIG. 6 is a flowchart depicting an exemplary embodiment of a method of controlling food efficiency in a livestock farm;

FIG. 7 is an illustration of an exemplary embodiment of a vertical rod gate;

FIG. 8 is an illustration of an exemplary embodiment of a horizontal finger gate;

FIG. 9 is an illustration of an exemplary embodiment of a dual axes gate;

FIG. 10 is an illustration of an exemplary embodiment of a vertical sticks gate; and

FIG. 11 is an illustration of an exemplary embodiment of a blocking gate.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### SUMMARY OF THE INVENTION

Accordingly, it is a principal object of the present invention to providing an efficient, easy-to-use, and cost effective, systems and methods for livestock management.

The invention provides a system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller.

The invention further provides a method for directing livestock comprising:

providing a system for directing livestock, the system comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller;

providing instructions by the computer to the controller to direct the livestock;

activating the signaling element;

signaling at least one livestock animal to approach the gate;

changing the state of the gate from the locked state to the unlocked state;

allowing passage of the at least one livestock element through the gate; and

changing the state of the gate to locked state.

The invention further provides a system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one controller in communication with the gate and the signaling element; and e) at least one computer in communication with the controller.

Additional features and advantages of the invention will become apparent from the following drawings and description.

### DETAILED DESCRIPTION OF EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. The invention provides a system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller.

In one embodiment, the controller is configured to receive instructions from the computer, and to exercise actions according to the instructions, wherein the actions are selected from: signaling the livestock animal to the gate; changing the state of the gate from the locked state to the unlocked state; changing the state of the gate from the unlocked state to the locked state; maintaining the gate in an unlocked and/or locked state for a predetermined time interval; activating the signaling unit; inactivating the signaling unit; activating the animal identification unit; and, inactivating the animal identification unit. In one embodiment, the controller is configured to maintain the gate at the unlocked state for a predetermined time interval, wherein said predetermined time interval is sufficient to allow passage of a single livestock animal through the gate.

In another embodiment, the controller is configured to repeatedly change the state of the gate from the locked state to the unlocked state, and, to maintain the gate at the unlocked state for the predetermined time interval, wherein said predetermined time interval is sufficient to allow passage of a single livestock animal through the gate. In yet another embodiment, the controller is configured to maintain the gate at the unlocked state for the predetermined time interval, wherein said predetermined time interval is sufficient to allow passage of a predetermined number of livestock animals through the gate. As used herein, the term “predetermined time interval” refers, without limitation to a period of time, duration of which is preset either manually or automatically. As used herein the term “predetermined number of livestock animals” refers, without limitation, to a number of livestock animals which is decided upon in advance of setting the system of the invention, to allow the controller to maintain the gate in the unlocked state enough time to allow the passage of said number of livestock animals through the gate. In one embodiment, the gate mechanism is configured to allow passage of the at least one livestock animal in unidirectional manner. In yet another embodiment, the gate mechanism is configured to allow passage of at least one livestock animal in a bi-directional manner. In one embodiment, the opening of the gate in the unlocked state is triggered by the motion of the livestock animal. As used herein, the phrase “motion of the livestock animal” refers, without limitation to the situation when the livestock animal approaches the gate and comes into a physical contact with the gate. In one embodiment the opening of the gate in the unlocked state is automated. As used herein, the term “automated” refers, without limitation to a process carried out automatically, without needing human control. In one embodiment, the gate opening is triggered by livestock animal identification data acquired by the animal identification unit of the invention. Animal identification data acquired by the animal identification unit is transmitted to the controller and to the computer. The animal identification data is then processed, verified and instructions to open the gate are sent to the controller. In one embodiment, the system comprises at least two gates. In yet further embodiment, the system comprises multiple gates. In one embodiment the system is configured to allow passage of multiple livestock animals. In one embodiment, the controller is configured to change the state of each of the gates independently of each other. wherein the signaling element is configured to generate a plurality of signals. In one embodiment, the controller operates the signaling element to signal the livestock animal to approach a one, but not the other gate. In one embodiment, the signal is different for each gate. In another embodiment, the signal is identical for all gates. In one embodiment, the signal is identical for each livestock animal. In another embodiment, the signal is identical for groups of livestock animals. In one embodiment, the system comprises more than one signaling element. In one embodiment, the system comprises more than one controller. In one embodiment, the gate is situated at the opening of an enclosed area where the at least one livestock animal resides. In one embodiment, the enclosed area is surrounded by: a fence, a railing, a stockade, a palisade, a partition, a wall, a grille, and a divider. In one embodiment, the system is designed to serve as a sorting gate. In one embodiment, the animal identification unit is an image acquisition sensor or data reader. In one embodiment, the system further comprises animal activity identification unit in communication with the controller. In one embodiment, the system further comprises animal activity identification unit in communication with the controller. In one embodiment, the data related to the activity of the individual livestock animal are related to feeding behavior of said livestock animal. In one embodiment, the data related to food behavior are selected from: food intake; feeding time; body weight prior to feeding; body weight after feeding; type of food; or a combination thereof. the at least one livestock animal is trained to recognize the signal generated by the at least one signaling element. In another embodiment, the at least one livestock animal is trained to recognize the signal generated by the at least one signaling element and to approach the gate. As used herein, the term “trained” refers, without limitation, to acquiring particular skill or type of behavior by the livestock animal through practice and instruction over a period of time. According to one embodiment, the livestock animal is selected from beef cattle, dairy cattle, sheep, goats, horses, and pigs.

In one embodiment of the invention provided a method for directing livestock comprising:

providing a system for directing livestock, the system comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller;

providing instructions by the computer to the controller to direct the livestock;

activating the signaling element;

signaling at least one livestock animal to approach the gate;

changing the state of the gate from the locked state to the unlocked state;

allowing passage of the at least one livestock element through the gate; and

changing the state of the gate to locked state.

In one embodiment, the method further comprises the step of identification of the at least one livestock animal by the animal identification unit.

In one embodiment, the invention provides A system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one controller in communication with the gate and the signaling element; and e) at least one computer in communication with the controller. In another embodiment, the controller is configured to receive instructions from the computer, and to exercise actions according to the instructions, wherein the actions are selected from: signaling the livestock animal to the gate; changing the state of the gate from the locked state to the unlocked state; changing the state of the gate from the unlocked state to the locked state; maintaining the gate in an unlocked and/or locked state for a predetermined time interval; activating the signaling unit; and, inactivating the signaling unit. In another embodiment, the system further comprises further comprising animal identification unit in communication with the controller. In another embodiment, the controller is further configured to activate the animal identification unit; and, to inactivate the animal identification unit.

Unless explicitly stated, the method embodiments described herein are not constrained to a particular order or sequence. Additionally, some of the described method embodiments or elements thereof can occur or be performed simultaneously, at the same point in time, or concurrently.

Some aspects of the invention may be directed to an automatic sorting system for directing and sorting livestock. In the context of the invention, livestock (e.g., beef and dairy cattle, sheep, goats, domestic pigs, horses, etc.) are herdic animals that prefer to move in groups and are sensitive to sounds made by a group leader or a shepherd. A system according to embodiments of the invention may allow to signal a single livestock animal or a group of animals in the herd. A non-limiting list of signals includes sounds, vibration, touch, light, electric current, and smell. The signal is generated by a signaling element, which can be situated, without limitation, on the gate, along the pass to the gate, on the livestock animal, or any other location where generated signal can reach the animal. According to the invention, the signal is recognizable by the livestock animal and is associated with a certain stimuli and/or action. The non-limiting examples of signals and correlated stimuli and/or actions include: light from the gate signaling to the animal to approach the specific gate; light showing the animal the way to the correct gate; light signaling to an individual animal that the gate is closed; light signaling to the an individual animal that the gate is open; light signaling to a group of animals that the gate is closed; light signaling to a group of animals that the gate is open; sound coming from the gate signaling to the animal to approach the gate; pleasant sound correlated with pleasant and rewarding action; unpleasant sound correlated with punishment, for instance sound indicating that the animal is moving in the wrong direction; vibration from the device located on the animal; certain type of vibration associated with pleasant and rewarding action; certain type of vibration associated with negative and punishing action; vibrating device which is not situated on the animal. The signal is an indication that a specific gate is unlocked and may be opened.

In some embodiments, when reaching the gate, the gate mechanism may allow the animal itself to push and open the gate and pass through the gate or an opening in a barrier such as a fence, a wall or the like. In some embodiments, the system may include identifying the passing animal using a tag attached to the animal. In some embodiments, on the other side of the gate the animal may find an activity, such as a feeding station, a milking machine (e.g., a robotic milking system), a resting place, a treatment station and the like. Embodiments of the system may facilitate granting of a passage permission through a specific gate to only a selected group of animals. For example, the permitted animals may approach the specific gate, and may be allowed to pass through it, even if not previously called upon to come (e.g., signaled). According to some embodiments of the invention, a gate may have a locked state and an unlocked state. When in an unlocked state, the gate may be opened with only a slight push by the animal. Thus, an animal that is permitted to pass through the gate may find the gate unlocked and may pass therethrough, on its way to, for example, a feeding station. In a complimentary manner, animals that are not permitted to pass may find the gate locked and may not be able to pass through the gate. A system according to embodiments of the invention may identify the animal approaching the gate and may change the state of the gate according to the permission of each animal.

In some embodiments, such a system may allow collecting data related to the behavior and activity of each animal. For example, a sensor such as a scale may be attached to a manger filled with food located beyond the gate. When an identified animal passes through the gate, embodiments of the system may receive from the sensor (e.g., the scale) the weight of the manger at the beginning of the feeding and the weight after the animal has left the manger. Embodiments may consequently calculate how much food the animal has consumed. The amount of food consumed by each livestock animal may be correlated with the production of each animal. This information may be accumulated over a period of time (e.g., at a specific day, over a number of days, weeks, months, years, etc.) Collecting such data for a group of animals or even for the entire herd may allow efficient and more accurate feeding of the herd, thus increasing the productivity of the herd and the food efficiency of the livestock farm.

The term food efficiency (FE) is used in the art to indicate a relation between a livestock animal's food consumption and its productivity. As a simplistic example, FE of a specific cow may indicate a ratio between the cow's production of milk and the amount of food consumed by that cow.

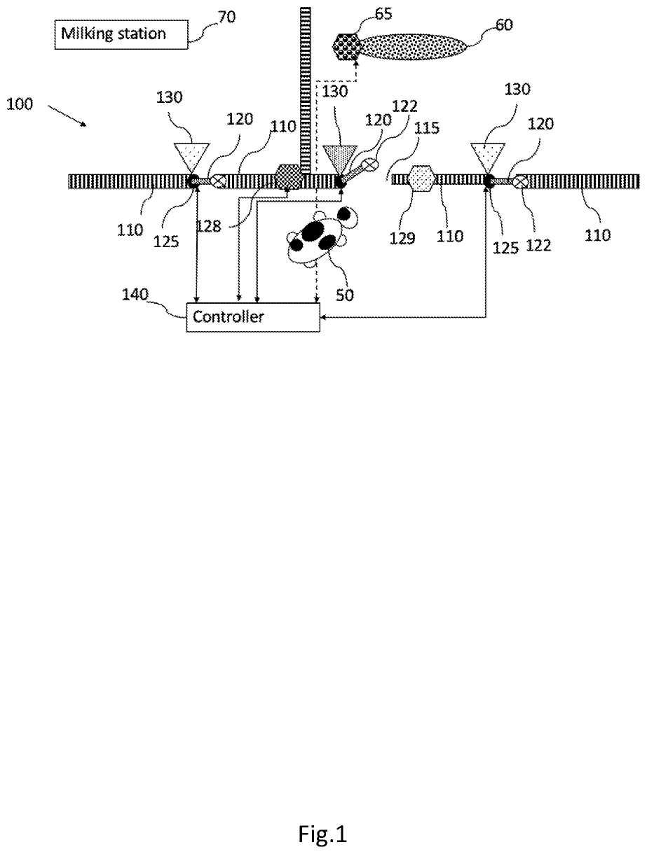

Reference is now made to FIG. 1 which is an illustration depicting an example of a system 100 for directing livestock according to some embodiments of the invention. System 100 may include at least one barrier 110 for holding livestock.

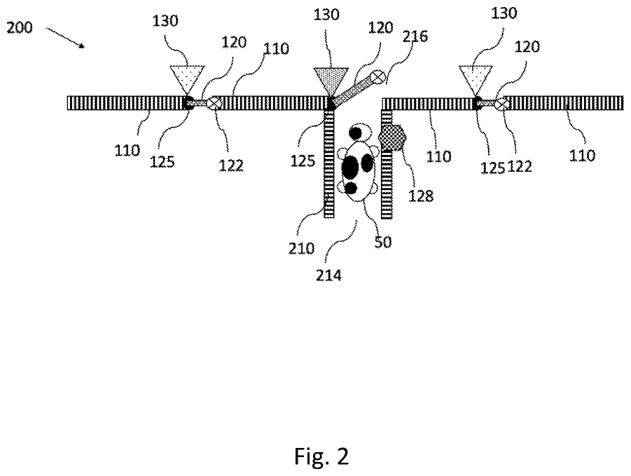

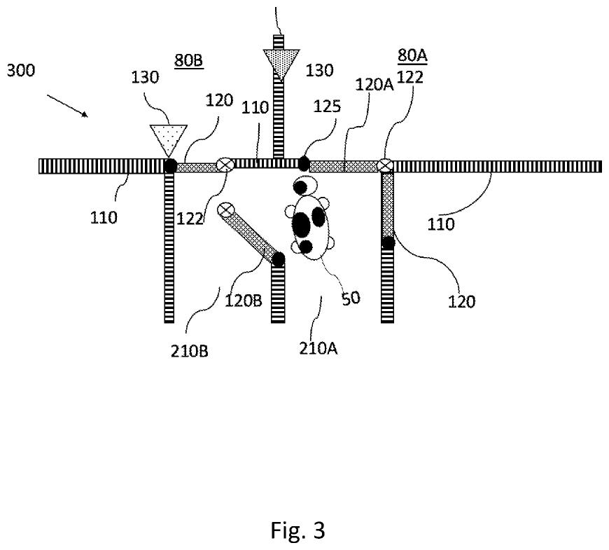

For example, barrier 110 may surround or encircle a livestock compound (e.g., a cowshed, an animal pen and the like) or a part thereof. Barrier 110 may include one or more openings 115 including, for example, the three openings illustrated in FIG. 1. In some embodiments, barrier 110 may include any object or obstacle that does not allow animals, such as a livestock animal 50 (e.g., a single cow, a bull, a sheep, a goat, a horse, etc.), to go freely from one side to the other. For example, barrier 110 may be: a fence, a railing, a stockade, a palisade, a partition, a wall, a grille, a divider an electric fence and the like. In some embodiments, barrier 110 may include a barriered path or corridor 210 having an entrance 214 at a first end of the path and the at least one exit 216 at a second end of the path, as illustrated and discussed with respect to FIG. 2 and FIG. 3. It should be appreciated that system 100 may be, according to some embodiments, portable and movable (e.g., deployed at a meadow, where a herd may be grazing). According to alternate embodiments, system 100 may be affixed at a single location or area (e.g., at a cowshed). In some embodiments, system 100 may include one or more gates 120 having a locked state and unlocked state, each gate 120 being located in one opening 115 of barrier 110.

In some embodiments, in the unlocked state, gate 120 may be opened to one, selected, direction. In alternate embodiments, in the unlocked state, gate 120 may be opened to two directions.

In some embodiments, controller 140 may set the state of gate 120 to the unlocked state, according to the identity of an individual animal that may approach the gate (as discussed with respect to FIG. 3).

One or more gates 120 may be made or may include any form or material for making gates or doors. According to some embodiments of the invention, gate 120 may be light enough to be opened by a pushing made by livestock animal 50.

In some embodiments, each gate 120 may further include a locking/unlocking mechanism 122. For example, the locking mechanism may include any electromagnetic device (e.g., a solenoid) known in the art of locking mechanisms.

In some embodiments, the system may include one or more gate mechanisms 125, each connected to at least one gate 120 and configured to allow passage of at least one livestock animal through the gate when the gate is in the unlocked state.

Gate mechanism 125 may allow gate 120 to be opened by pushing gate 120 (either intentionally or unintentionally) when gate 120 is unlocked, for example, gate mechanism 125 may include a shaft or hinge that may allow gate 120 to be opened by pushing. In some embodiments, gate mechanism 125 may include a returning mechanism (e.g., a returning spring, a returning piston and the like), for returning the opened gate to a closed position.

In some embodiments, gate mechanism 125 may have at least one state, selected from a unidirectional state, allowing passage of a livestock animal through the gate in a selected single direction and a bidirectional state, allowing passage of a livestock animal through the gate in both directions. For example, gate mechanism 125 may enable an animal to push through gate 120 and may cause gate 120 to close after the animal has passed, thus disallowing the animal to pass the gate in the opposite direction. Alternately, gate mechanism 125 may enable an animal to push through gate 120 in a first direction and return in its track by pushing through the gate in the opposite direction.

In some embodiments, system 100 may further include an animal identification unit 128 for reading at least one data from at least one corresponding identification element. In some embodiments, the at least one identification element may be attached to livestock animal 50.

For example, animal identification unit 128 may be an RFID reader, a barcode reader and the like, adapted to read at least one data element from a corresponding machine-readable element (e.g., an RFID tag). Alternatively, animal identification unit may be based on artificial intelligence (AI). In some embodiments, the machine-readable element may include at least an identification of each livestock animal 50 (e.g., an identifying number). Accordingly, reader 128 may be configured to read at least one data element including the identity of livestock animal 50 when animal 50 passes near or through gate 120. controller 140 may be configured to identify livestock animal 50 according to the at least one read data element.

In some embodiments, system 100 may include a camera 129 that may capture at least one image of at least one livestock animal approaching one or more gates 120. For example, camera 129 may be associated with one or more proximity sensors (not shown), adapted to detect movement and/or existence of at least one livestock animal that may be approaching the gate. In some embodiments, controller 140 may be configured to analyze at least one captured image, according to any suitable image analysis method known in the art to identify the at least one approaching animal based on the image of the animal captured by camera 129.

In some embodiments, system 100 may include a signaling element 130 configured to signal the livestock. For example, signaling element 130 may include a loudspeaker for providing a signal that may include playing at least one tune or sound. In another example, signaling element 130 may include a light source (e.g., a lamp) for providing a light signal, such as a flashing the light, producing light at a specific color, producing light at a specific pattern and the like. In yet another example, one or more signaling elements 130 may be attached to respective one or more livestock animals (e.g., on a tag, a collar, and the like). The one or more signaling elements 130 may include a vibrating element, adapted to produce a vibration signal (e.g., one or more thumps, a continuous vibration and the like) for signaling or calling the animal. In some embodiments, signaling element 130 may be located in proximity to gate 120, at a central place in the livestock shelter or compound and may be detectable by the livestock (e.g., visible, in clear view to the livestock, at a place that may allow a sound to be heard by the livestock and the like). Alternately, or additionally, a plurality of signaling elements 130 may be attached to a respective plurality of animals (e.g., on a tag, a collar and the like). For example, signaling elements 130 may be attached to a tag of the animal, a collar worn by the animal and the like. In such embodiments, signaling element 130 may produce various sounds, vibrate at various frequencies and the like, according to the identity of each animal.

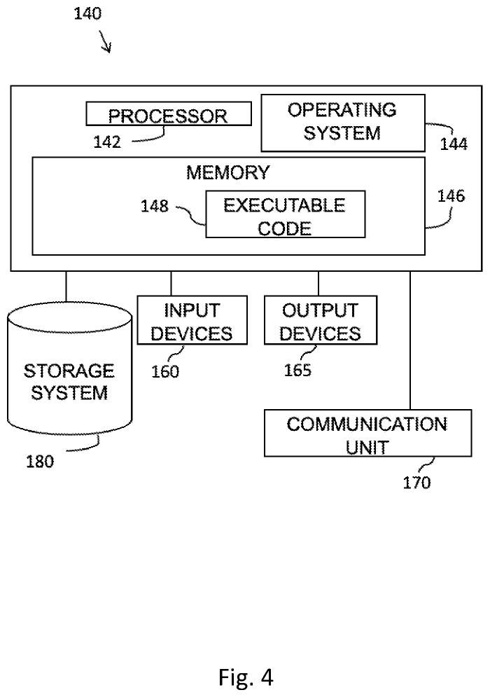

In some embodiments, system 100 may include a controller 140, discussed in more details with respect to FIG. 4. and at least one sensor 65, communicatively connected to controller 140, configured to collect data related to one of: the behavior of an identified livestock animal 50, the conditions in cattle shed, a barn, a pen or any other facility or area accommodating livestock, the environmental conditions and the like.

In some embodiments, sensor 65 may be associated with an activity that may await livestock animal 50 in a location beyond gate 120.

For example, gate 120 may lead to a location of a feeding station 60. sensor 65 may be a scale configured to measure the weight of a manger included in feeding station 60. In some embodiments, sensor 65 (e.g., the scale) may be configured to measure the weight of the manger at the beginning of the feeding of identified livestock animal 50 and after animal 50 finished eating. A controller (e.g., controller 140) may be communicatively connected to sensor 65 and may receive the outcome of weighing therefrom. Controller 140 may thus calculate how much identified animal 50 ate, at a particular date and time.

In another example, gate 120 may lead to a location of milking station. Sensor 65 may be configured to measure the milk production of a livestock animal (e.g., a cow, a sheep, a goat, a buffalo, a camel, etc.) in the milking station. In some embodiments, sensor 65 may be configured to measure the amount of milk produced by a single livestock animal in a single milking session.

According to some embodiments, controller 140 may receive information from at least one element of system 100 and control at least one controllable element of system 100.

For example, controller 140 may receive (e.g., via a user interface) a request for directing a first livestock animal 50 to pass through first gate 120 (as illustrated in FIG. 1). and receive (e.g., from reader 128, from camera 129, etc.) at least one data element including identification information pertaining to first livestock animal 50 (e.g., from a first machine readable element that may be attached to animal 50 or from a captured image of livestock animal 50, respectively). Controller 140 may identify first livestock animal 50 according to the received identification information and may then change the state of the locking mechanism of gate 120, for example, from locked to unlocked.

Controller 140 may provide, by signaling element 130, a first signal to first livestock animal 50. The first signal may indicate the change in the state of first gate 120 (e.g., that the gate has been unlocked). Following the change of the unlocking of first gate 120, livestock animal 50 may try to pass thought gate 120 by pushing its way through (either intentionally or unintentionally) the gate. In some embodiments, after a small number (e.g., less than 5) successful attempts, livestock animal 50 may be able to connect the first signal (e.g., a specific sound or tune) to the opening of first gate 50 and optionally also to the activity that may await livestock animal 50 (e.g., eating) beyond gate 120.

According to alternate embodiments, directing the livestock to appropriate gates may rely on the identification of one or more animals and may not include signaling or calling one or more animals.

For example, embodiments may include location of one or more gates 120 (e.g., two, as in the example depicted in FIG. 1) having a locking mechanism 122, that may be communicatively connected to at least one processor or controller 140. Controller 140 may identify a livestock animal that may be approaching a first gate 120 and may set a state of locking mechanism 122 of at least one gate according to the identification of the animal.

For example, controller 140 may set a state of locking mechanism 122 of a first gate 120 (e.g., a gate leading to a first type of food) to be locked, to disallow passage of an animal through the first gate (e.g., prevent access of the first animal to the first type of food). Controller 140 may set a state of locking mechanism 122 of a second gate 120 (e.g., a gate leading to a second type of food) to be unlocked, to permit passage of the animal through the second gate 120 (e.g., allow access of the first animal to the second type of food).

Reference is now made to FIG. 2 which is an illustration depicting an example of a system 200 for directing livestock according to some embodiments of the invention. System 200 may include substantially the same elements as system 100 illustrated in FIG. 1.

In some embodiments, barrier 110 of system 200 may surround a livestock compound (e.g., a cow shed, an animal pen and the like) including a barriered path or corridor 210. Barriered path 210 may have an entrance 214 at a first end of the path and at least one exit or opening 216 at a second end of the path. In some embodiments, barriered path 210 may have a shape of a corridor. In some embodiments, barriered path 210 may include two or more exits or openings 216, each adapted to directing livestock animal 50 to a different location. Each exit or opening 216 may include a gate 120, having a state selected from a locked state and an unlocked state. Gate 120 of system 200 may be identical to gate 120 of system 100.

System 200 may further include at least one gate mechanism 125, a reader 128 and a signaling element 130. System 200 may include a controller 140 (not illustrated). System 200 may include or may be associated with sensor 65, as discussed with respect to system 100.

Reference is now made to FIG. 3 which is an illustration depicting an example of a system 300 for directing livestock according to some embodiments of the invention. System 300 may include substantially the same elements as system 100 illustrated in FIG. 1 and system 200 illustrated in FIG. 2. Barrier 110 of system 300 may include two or more barriered paths 210 (e.g., 210A, 210B) each having an entrance at a first end of the path and at least one exit at a second end of the path. In some embodiments, barriered paths 210A may have two or more exits or openings at one end, each including a gate 120. In some embodiments, first barrier path 210A may direct livestock animal 50 to a first location 80A via front gate 120 (e.g., 120A). However, if animal 50 located at barriered path 210A needs to be moved to a second location 80B or to be sorted out from animals directed to first location 80A, a side gate 120 (e.g., 120B) may be opened while front gate 120A may be closed. Accordingly, livestock animal 50 may pass from barrier path 210A to barrier path 210B. In some embodiments second barrier path 210B may direct livestock animal 50 or another livestock animal to second location 80B. In some embodiments, first location 80A may be associated with a first activity, e.g., feeding, and second location 80B may be associated with a second activity, e.g., resting.

Reference is made to FIG. 4, which is a schematic block diagram of an example of a controller, according to some embodiments of the invention. Controller 140 may include a processor 142 (e.g., a central processing unit processor (CPU), a graphics processing unit (GPU), a chip or any suitable computing or computational device), an operating system 144, memory 146, executable code 148, storage 180, input devices 160 (e.g. a keyboard or touchscreen), and output devices 165 (e.g., a display), a communication unit 170 (e.g., a cellular transmitter or modem, a Wi-Fi communication unit, or the like) for communicating with remote devices via a communication network, such as, for example, the Internet. Processor 142 of controller 140 may be configured to execute program code to perform operations described herein. The system described herein may include one or more controller(s) 140.

Operating system 144 may be or may include any code segment (e.g., one similar to executable code 148 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 146 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 146 may be or may include a plurality of, possibly different memory units. Memory 146 may be a computer or processor non-transitory readable medium, or a computer non-transitory storage medium, e.g., a RAM.

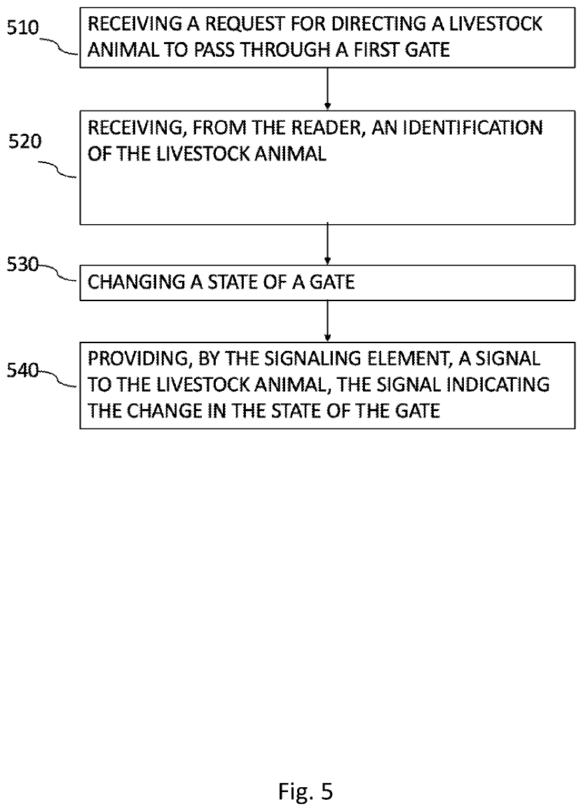

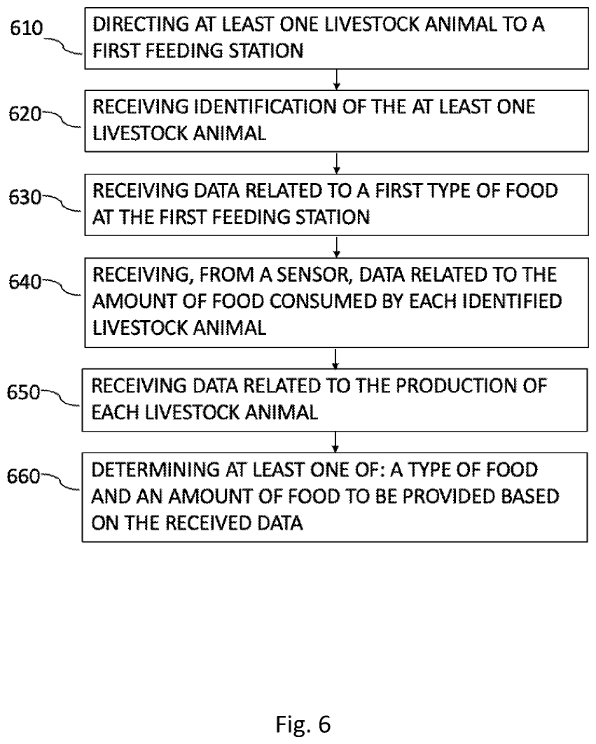

Executable code 148 may be any executable code, e.g., an application, a program, a process, task or script. Executable code 148 may be executed by processor 142 possibly under control of operating system 144. For example, executable code 148 may be a software application that performs methods as further described herein, for example, for controlling directing livestock or methods of controlling a food efficiency of a livestock farm, disclosed and discussed with respect to FIG. 5 and FIG. 6. Although, for the sake of clarity, a single item of executable code 148 is shown in FIG. 1, a system according to embodiments of the invention may include a plurality of executable code segments similar to executable code 148 that may be stored into memory 146 and cause processor 142 to carry out methods described herein.

Storage 180 may be or may include, for example, a hard disk drive, a universal serial bus (USB) device or other suitable removable and/or fixed storage unit. In some embodiments, some of the components shown in FIG. 1 may be omitted. For example, memory 146 may be a non-volatile memory having the storage capacity of storage 180. Accordingly, although shown as a separate component, storage 180 may be embedded or included in memory 146.

Input devices 160 may be or may include a keyboard, a touch screen or pad, one or more sensors or any other or additional suitable input device. Any suitable number of input devices 160 may be operatively connected to controller 140. Output devices 165 may include one or more displays or monitors and/or any other suitable output devices. Any suitable number of output devices 165 may be operatively connected to computing device 100. Any applicable input/output (I/O) devices may be connected to controller 140 as shown by blocks 160 and 165. For example, a wired or wireless network interface card (NIC), a universal serial bus (USB) device or external hard drive may be included in input devices 160 and/or output devices 165. Communication unit 170 may be configured to communicate, either wirelessly or by wired communication with the controllable elements of systems 100, 200 and 300. For example, communication unit 170 may be configured to receive readings from reader 128, signals and data from sensor 65, may communicate with the locking mechanism of gates 120 and may communicate with signaling element 130.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 146, computer-executable instructions such as executable code 148 and a controller such as processor 142. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 146 is a non-transitory machine-readable medium.

A system according to embodiments of the invention may include components such as, but not limited to, a plurality of central processing units (CPU), GPUs, or any other suitable multi-purpose or specific processors or controllers (e.g., controllers similar to processor 142), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

Reference is now made to FIG. 5 which is a flowchart of a method of directing livestock according to some embodiments of the invention. The method of FIG. 5 may be performed by system 100 and more precisely by controller 140 of system 100, or any other suitable controller.

In box 510, a request for directing a first livestock animal to pass through a first gate may be received. For example, controller 140 may receive from input device 160 or from a code stored in memory 146 a request for directing livestock animal 50 to pass through gate 120. In some embodiments, controller 140 may receive a request for directing a second livestock animal to pass through first gate 120 or to direct the second livestock animal to pass through a second gate 120 different from the first. In some embodiments, controller 140 may receive a request for directing the first livestock animal to pass through second gate 120. In some embodiments, controller 140 may receive a request for directing a first group of livestock to pass the first gate and a second group of livestock to pass through the second gate.

In some embodiments, first gate 120 may lead to a first location associated with a first activity, such as a feeding station that may include a manger, and second gate 120 may lead to a second location, associated with a second activity, such as a milking station that may include a milking machine, as illustrated in FIG. 2. In some embodiments, at least one of the first, second or a third gate may be included in a barriered path, as illustrated in FIG. 2 and FIG. 3.

In box 520, an identification of the first livestock animal, may be received. In some embodiments, the identification may be received form a reader reading a first machine readable elements attached to the animal. For example, an RFID tag may be attached to livestock animal 50, thus when livestock animal 50 approaches gate 120, reader 128 may read the tag and send at least one data element including identifying data stored on the tag to controller 140. In some embodiments, controller 140 may receive from a reader, associated with each gate 120 of system 100, the identification of each livestock animal (e.g., a first animal, a second animal, etc.) approaching the gate.

In some embodiments, system 100 may include a camera 129 that may be communicatively connected to controller 140 and may be configured to capture an image of a livestock animal approaching at least one gate. For example, camera 129 may be associated with one or more proximity sensors, adapted to detect movement and/or existence of at least one livestock animal that may be approaching the gate. Controller 140 may receive at least one image of the animal approaching the gate from camera 129, and may identify the animal based on the received image, using any known image analysis and image recognition techniques known in the art.

Additionally, or alternately, controller 140 may receive the identification of livestock animal 50 from other sources, for example, from a user via a user interface or the like and the invention is not limited to a specific form of receiving identification of a livestock animal.

In box 530, a state of the first gate may be changed. For example, gate 120 may have a state selected from a locked state and an unlocked state. Controller 140 may control a locking mechanism of first gate 120 to unlock first gate 120. In some embodiments, controller 140 may control at least one locking mechanism of at least one other gate to be locked. In some embodiments, when first gate 120 is at an unlocked state, only a slight push from a passing livestock animal may be required to open the gate, allowing the livestock animal to push its way through gate 120.

In box 540, a first signal may be provided to the first livestock animal by a first signaling element, the first signal indicates the change in the state of the first gate.

For example, controller 140 may control signaling element 130 (e.g., a loudspeaker) to provide a tune or a sound (e.g., a whistle) indicating that first gate 120 leading to feeding station 60 is open. In some embodiments, each signal may be associated with the identity of each animal, such that the first signal may be provided to first livestock animal 50 and a second signal, indicating that first gate 120 is open may be provided to a second livestock animal. The second signal may be provided to the second livestock in order to direct the second livestock animal to pass the first gate. In some embodiments, a third signal may be provided to the first livestock animal or to the first group of livestock directed to pass through a second gate 120.

In some embodiments, the first and second signals may differ, for example, by the type of tune or sound, the height of the notes, the length of the sound etc.

In some embodiments, signaling element 130 may be a lamp, and the signals may be light signals provided by the lamp. A first light signal and a second light signal may differ, for example, by a pattern of flashing light, a color of the light signal, and the like. In some embodiments, signaling element 130 may be a vibrating element that may be attached to the animal and the signals may be vibration signals that may be produced by the vibrating element.

In some embodiments, signaling element 130 may be located within the livestock compound so that it may be noticeable by a plurality of animals therein. For example, a signaling element that is a light source may be centrally located so that it may be noticed by all the animals in the compound.

Additionally, or alternately, signaling element 130 may be located on one or more livestock animals. For example, a signaling element 130 that may be a vibrating element, or a sound-producing element may be attached to a specific animal and may be employed to individually signal or call that specific animal.

In some embodiments, different signals (e.g., different colors of light signals) may be provided to different animals or groups of animals. A system and method according to embodiments of the invention may allow to direct any identified animal or any identified group of animals to pass through any gate included in system 100. The method may allow controlling the animal traffic in the farm, by directing different animals to different locations, thus preventing for example, over population of specific areas and locations in the farm.

Furthermore, a system and method according to embodiments of the invention may allow collecting data related to each identified animal, after the animal passed a specific gate. In some embodiments, some of gates 120 may be associated with activities, such as feeding or milking and controller 140 may collect data related to these activities, as discussed in more details with respect to the flowchart of FIG. 6. The collected data may allow increasing the efficiency of the farm, by providing more accurate data regarding the amount of food consumed by each livestock animal, reducing waste and increasing livestock productivity (e.g., production of milk, wool, meat, etc.).

Reference is now made to FIG. 6 which is a flowchart of a method of controlling food efficiency of a livestock farm according to some embodiments of the invention. The method of

FIG. 6 may be performed and executed by a controller such as controller 140, or by any other suitable controller.

In step 610, at least one livestock animal may be directed to a first feeding station. For example, controller 140 may control the locking mechanism of gate 120 leading to feeding station 60 to be unlocked and signaling element 130 to produce a signal associated with the feeding station, thus signaling to the at least one livestock animal that food is available there.

In some embodiments, controller 140 may direct, over a predetermined amount of time, a plurality of animals. For example, during a single day, controller 140 may direct livestock 50 to pass through the first gate and to be fed in feeding station 60. Controller may direct the same livestock 50 to pass through the first gate for 10 consecutive days, to allow collection of data over this time period.

In box 620, an identification of the at least one livestock animal may be received. In some embodiments, controller 140 may receive (e.g., from reader 128, from camera 129, etc. as explained herein) the identification of each livestock animal passing through gate 120.

In box 630, data related to a first type of food at the first feeding station may be received. For example, the farmer may input (e.g., via a user interface in input device element 160 of FIG. 4) the type of food placed in the manger of feeding station 60. The type of food may be, for example, forage (e.g., grass or hay), a mixture of forage and concentrate (e.g., a mixture of carbohydrates, proteins, fats, and minerals and vitamins) and the like. In some embodiments, the data may be received from a database (e.g., storage element 180 of FIG. 4) that may include data related to the food provided to each manger during a particular day, week, month, season and the like.

In box 640, data related to the amount of food consumed by each identified livestock animal, may be received from a sensor 65, communicatively connected to controller 140. For example, a sensor 65 may be a scale, configured to measure the weight of manger 60 before livestock animal 50 started eating and after livestock animal 50 finished eating and controller 140 may calculate the amount of food consumed by livestock animal 50 during the feeding session. Controller 140 may calculate the amount of food for each identified livestock animal passing through gate 120 and eating from the manger in feeding station 60.

In box 650, data related to the productivity of each livestock animal may be received. For example, controller 140 may receive data related to an amount of milk produced by each identified livestock animal from a robotic milking machine 70. In another example, controller 140 may receive an amount of wool produced by the animal from a sheep shearing station. In some embodiments, controller 140 may be communicatively connected to at least one second controller associated with livestock productivity, to automatically receive data relating to the productivity of at least one livestock animal therefrom. Pertaining to the example of the robotic milking machine 70 above, controller 140 may automatically receive at least one data element including information about the production of milk of a specific cow from a second controller associated with milking machine 70. Alternately, or additionally, controller 140 may enable a user (e.g., a farmer) to input the production information (e.g., via input device 160 of FIG. 4).

In some embodiments, directing at least one livestock animal to a first feeding station and receiving the data may be carried out for each livestock animal over a predetermined period of time. Therefore, a method according to some embodiments of the invention may allow to associate between the food consumption and the productivity of individual livestock animals.

In box 660, at least one of: a type of food and an amount of food to be provided based on the received data may be determined. In some embodiments, controller 140 may determine the type of food and/or an amount of food that may increase the food efficiency of the farm. For example, controller 140 may correlate between the amount and the type of food consumed by the animal and its productivity at each day for 10 days.

The controller may select to increase or decrease the amount or change the mixture provided to each livestock animal in order to increase the productivity of the animal (e.g., increase the amount of milk).

In some embodiments, controller 140 may determine at least one of: a type of food and an amount of food for a first group of livestock. For example, controller 140 may decide to add more concentrate to a group of animals in order to increase their productivity. For example, controller 140 may direct this group to a second gate 120 leading to a second manger having higher percentage of concentrate in the provided food. In some embodiments, controller 140 may receive (e.g., via input device 160, from a database on storage element 180, and the like) data related to a profile of at least one livestock animal.

The received profile data of the at least one livestock animal may include, for example, data relating to the animal's age, gender, species, size, weight etc. In some embodiments, the profile data may include information relating to the animal's health, including for example occurrence of past or present illnesses, pregnancy, birth-giving, and the like.

Controller may further determine at least one of: a type of food and an amount of food to be provided also based on the received animal profile data. For example, controller 140 may determine an amount of concentrate that is to be provided based on the age of the animal. Controller 140 may group together animals having similar related data, for example, 2-4 years old animals after giving birth and may direct all these animals to a specific manger filled with a food mixture that may be suitable to this group of animals.

Therefore, a method and a system according to some embodiments of the invention may allow a farmer to feed individual animals with precise nutrition by directing the animals to a specific feeding station providing the nutrition. The farmer may use several mangers, each providing different types of food and direct specific individual animals to the most suitable manger. The farmer can load (automatically or manually) the precise amount of food to be provided to each animal. In some embodiments, system 100 may enable the farmer to provide to a single animal the first type of food at a first manger (e.g., loaded with forages) located beyond a first gate and a second type of food (e.g., the concentrate) at a second manger located beyond a second gate.

According to some embodiments of the invention, system 100 may include one or more signaling element 130 and a controller 140. In such case controller 140 may receive a request to direct a first livestock animal or a first group of livestock to a first location. The request may be received from a user interface included in input device 160 or from a code stored in memory 146. In some embodiments, system 100 may provide, by signaling element 130, a first signal selected to direct the first livestock animal to the first location. For example, a loud speaker included in signaling element 130 may provide to a first group of livestock included in a herd, a tune/sound indicating that food is provided in the mangers. In yet another example, signaling element 130 may provide to the entire herd a signal that a gate was opened (e.g., to the meadow) either manually or automatically. Common practice in modern milking farms typically dictates separation of young or newborn animals (e.g., calves, lambs and the like) from their mothers (e.g., cows, sheep etc.), causing much distress to the livestock. Currently, mothers and cubs are being separated at birth, due to the inability to control the amount of milk provided by the mother to the cub and to combine further milking of a nursing mother.

In some embodiments, system 100 may allow to manage mothers and newborns in a way that may allow newborns to be raised and fed by their mothers at a milking farm in the most natural and non-disruptive manner possible.

According to some embodiments, system 100 may be installed in a milking farm and may include at least one nursery area defined by a barrier such as barrier 110. The nursery area may be inhabited only with mothers and their young. System 100 may include substantially the same elements of system 100 of FIGS. 1-3. In some embodiments, controller 140 may control gate 120 that may be included in barrier 110 of the nursery area to only permit entrance and exit to mothers having young. Any other members of the herd may not be permitted to enter, the young or newborn may not be permitted to exit.

Accordingly, a reader 128 or camera 129 may send to controller 140 a signal or an image that may allow controller 140 to identify any livestock animal approaching the gate of the nursery area. However, only livestock that are identified mothers, as explained herein, may be allowed to pass in and out of the nursery area via gate 120.

Such an arrangement may allow mothers to spend time and nurse their young, while being fed and milked at other areas or locations of the cowshed. In some embodiments, the feeding and/or milking of one or more specific mothers may be controlled by providing directing signals to the mothers. For example, controller 140 may be configured to provide a first signal indicating that a food is being served in the mangers at the feeding station, to a first group of mothers, thus managing the traffic of animals near the manger. In some embodiments, the mangers may provide a food mixture suitable for nursing mothers.

In yet another example, controller 140 may be configured to produce a second signal indicating an invitation to be further milked, to a second group of mothers, for example, mothers having young that are older than 3 weeks. Such young may not need to be fed as frequently as newborns and may consume more milk than they actually need.

In some embodiments, a system and method according to some embodiments of the invention may allow to control the amount of time the mother spends with their young, by permitting mothers to enter the nursery only at specific periods of time. In some embodiments, such a system and method may allow a smooth a gradual ablactating of the young.

In some embodiments, the system of the invention has various applications. In one embodiment the system is used as a sorting corridor at the exit from the Milking parlor for cows. Currently sorting consists of a rear and anterior A model gate and a right and left turn by gates that open by the cow closed by gravity and are locked/not locked by electromagnetic lock. At present, the sorting corridors at the exit from the milking parlor require air compressor or rarely oil or vacuum pressure to operate the pistons required to divert the gates. No pistons and/or other power source to operate the new sorting corridor. The pistons create recoil and stress to the cows, thus slowing the sorting rate and impairing the quality of life of the cows. The cows are moving one after another in the corridor. Most cows move straight across the corridor.

When the cow is supposed to be turned right/left, the back-gate locks in front of the next cow. After the first cow has moved past the front gate, the piston moves to turn the cow right/left, the back gate opens and allows the second cow to enter the section between the two gates. Only after the first cow leaves the corridor (right/left, does the piston return the gate to the “straight/forward” position and then the rear gate opens for further movement. The sorting corridor of the invention creates recoil and has no downside. On the contrary, cows enjoy using the new sorting corridor gates. The back gate is closed behind the cow intended to be sorted so that the process is shorter and more reliable. The cows show less reluctance because there is no uncontrollable movement of the animal. Features such as speed, reliability, price, and no-stress, allow sorting by more than one corridor at a time. In another embodiment, the system is used for a sorting corridor for beef cattle in the corral-paddock. Currently no sorting corridors in beef cattle corral for meat are used. The sorting today is by pistons and manual control or manual sorting of moving gates by the human force. Sorting in cattle pens is more complex than sorting out of the milking parlor and results in even higher stress, due to the fact that this is not a routine daily operation but a rare occurrence and most cows are not accustomed to being in a close proximity to humans. In dairy farms cow size is quite similar in cattle herds there are young calves and double the cows weight bulls. In contrast to the calm and slow exit from the milking parlor cattle herds are often required to sort a lot of cows and in a short time. Corral in the paddock do not always have a power source for operating a compressor/oil pump. Occasionally, sorting is required for more than 3 options: left, right, and forward. Gates of invention can sort cows of any size. No power source is needed. Movement down the corridor without gates slammed in front of the cows lowers the stress. The system of the invention allows sorting more than one corridor at a time. In one embodiment, the system is used as sorting corridor for pasture. There is currently no sorting corridor for pasture as there is a need for high voltage source and the sorting corridors are now stationary and require relatively complex installation. The corridor of the invention does not require high voltage source. The corridor is not stationary, and its installation is simple. It allows to notify/signal to the cow or/and to herd when the gate is open. In another embodiment, the system is used as sorting gate for pasture. The gates can let the cow pass without the need for a corridor which means two-dimensional smart pass. The cow/herd can be notified/signaled when the gate is open. In one embodiment the system of the invention is used for moms & calf sorting gate in the dairy farms. Currently, the calves are in a compound adjacent to the herd but separated for a variety of reasons: the corral [the fences, gates, water trough] is built to the size of the adult cow herd to fit it into the size of young calves requires investment and is mostly uncomfortable for humans and cows, controlling and operating in a different area will ease their control. Controlling from who and how much did the calf suckled, “privacy” for the cow and calf after the Cow's litter, less stress and better attachment between the mother and the calf, protection from the weather. The mother is a part of the milking herd for all intents and purposes. In one embodiment, the system of the invention serves for gradual detox without stress between cow and calf. The system enables the entry of mother cow by permission, calves in a separate area, scheduling the suckling “X” time after milking in order to prevent overfeeding of milk to the calves. The end of the suckling period is done in a stressless way due to ability to take the number of suckling a day down very slowly while the cow and her calf can see each other and touch each other all the time. their “attachment” is going down while the importance of the suckling for the calf needs is gone. In one embodiment, the system of the invention is used for sorting to the feeding trough. Friendly and cheap sorting gate and the possibility of directing the cow to the right gate allows the farmer to navigate the cows to different sections of the feeding area. In one embodiment, the system of the invention is used for feeding tactics. Currently, the food is divided on the manger and apart from the food that the cows have pushed away and we push it back we can do nothing after the food distribution. The possibility of determining which animal will serve the food and when will open what we call “tactical” options that today there is no way to do. Decreased marginal output is often known to be the last “X” that consumed by a cow is economically inefficient, meaning that consuming 30 pounds of food a day produces profit and health, and 33 pounds of food produce less profit and less health. There is no way of measuring it today and no way to respond to it even if the information was accessible.

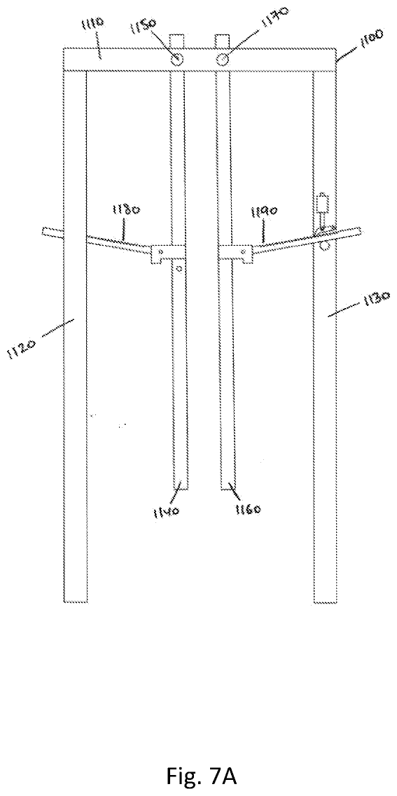

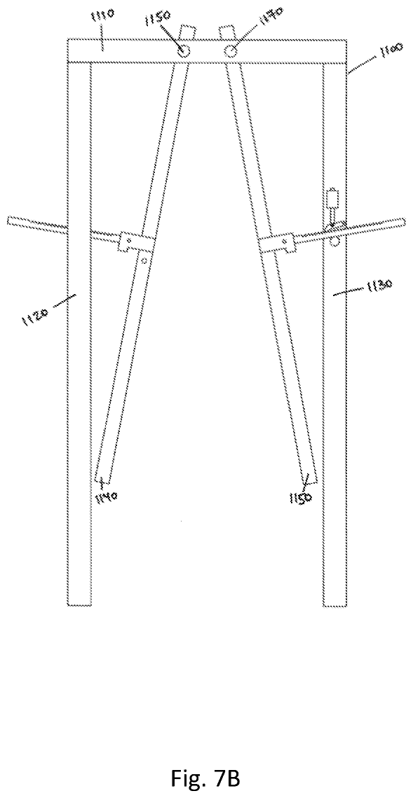

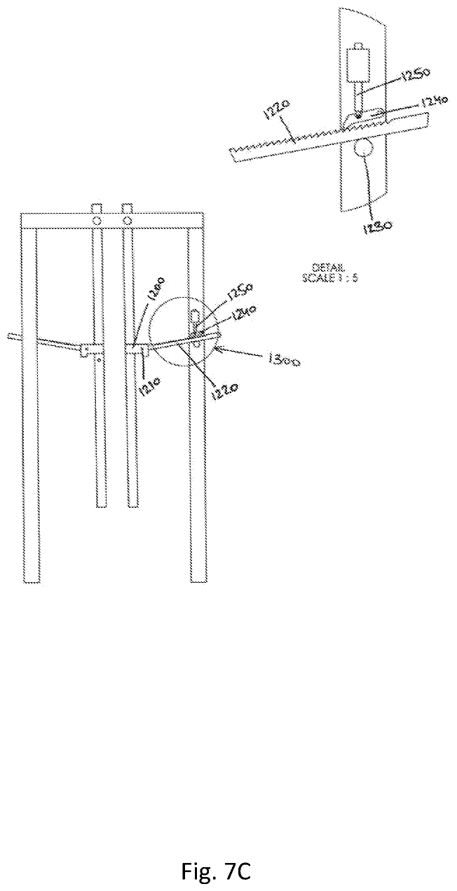

Reference is now made to FIG. 7A-C. FIG. 7A illustrates a high-level view of an exemplary embodiment of a vertical rod gate in a closed gate position. The vertical rod gate comprises: a frame of the gate 1100 that is comprised of a top bar 1110, a left bar 1120 and a right bar 1130; a left rod 1140 that is connected to the top bar 1110 of the frame 1100 by means of the rotational return spring axis 1150 that enables rotation of the left rod 1140 from its initial vertical position clockwise and backward to its initial position; a right rod 1160 that is connected to the top bar 1110 of the frame 1100 by means of the rotational return spring axis 1170 that enables rotation of the right rod 1160 from its initial vertical position counterclockwise and backward to its initial position; a left locking mechanism 1180 that restricts the rotation of the left rod 1140; and a right locking mechanism 1190 that restricts the rotation of the right rod 1160. The lowest end of the left vertical rod 1140and the right vertical rod 1160 do not reach the ground level to ensure easy rotation of the rods about the rotational return spring axes 1150 and 1170. In one embodiment the left rod 1140 and the right rod 1160 are attached to the frame 1100 being on the same plane with the frame. In another embodiment the left rod 1140 and the right rod 1160 are attached to the frame 1100 are on the same plane to each other but on different plane with the frame 1100. In another embodiment the left rod 1140 and the right rod 1160 are attached to the frame 1100 being placed in the different planes, each of them parallel to the plane of the frame 1100. FIG. 7B illustrates a high-level view of a vertical rod gate in an open gate position. In the open gate position, the left rod 1140 is rotated about the rotational return spring axis 1150 clockwise, while the right rod 1160 is rotated about the rotational axis return spring 1170 counterclockwise opening the gap between the left rod 1140 and the right rod 1160. FIG. 1C illustrates a side view of the right locking mechanism 1300. The mechanism is composed of a right shaft 1200 with a one face connected to the right rod 1160 and another protruding towards the right bar 1130 of the door frame 1100. The right face of the right shaft 1200 has an axis 1210 that attaches the toothed rack 1220. The toothed rack 1220 slides along and above the supported right pin 1230 of the right bar 1130 of the door frame 1100 and stops the motion of the toothed rack 1220 by means of the right guard 1240 and connected thereof right pinion 1250. In one embodiment, to pass the gate, the livestock animal shall split up the left rod 1140 and the right rod 1140, to the left and to the right respectively. When the livestock animal passed through the gate the bars return to their initial closed position.

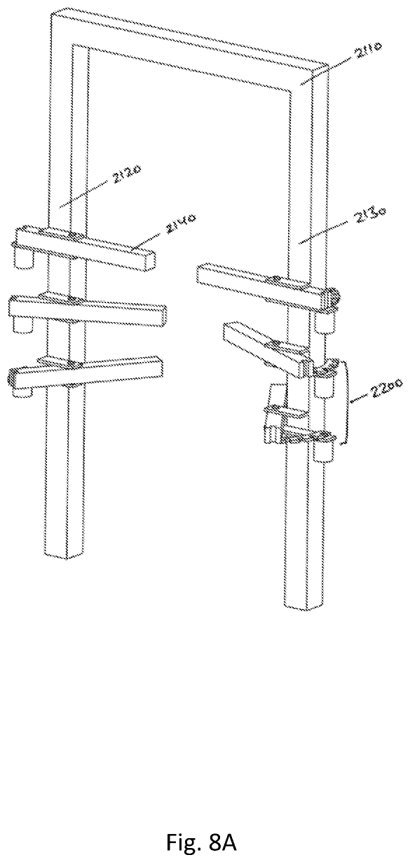

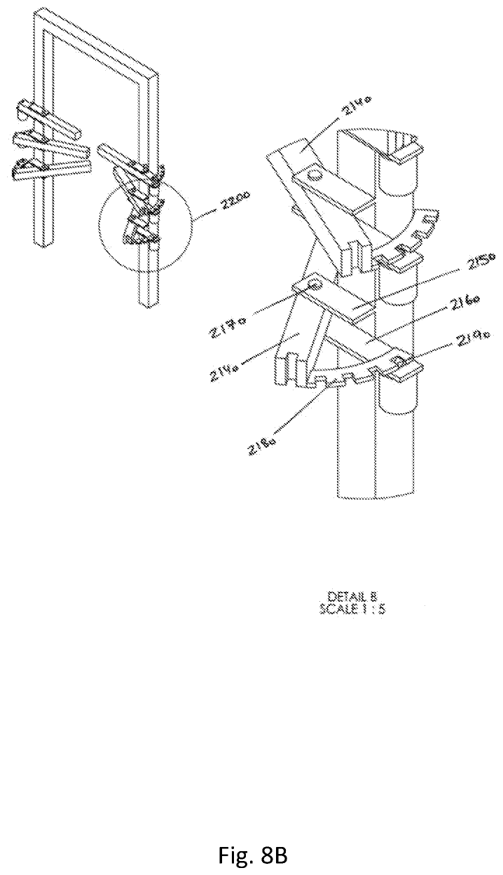

Reference is now made to FIG. 8A-B. FIG. 8 illustrates high level view of horizontal finger gate (FIG. 8A) and zoom in to the finger bars system (FIG. 8B). The horizontal finger gate comprises: (1) a frame 2110 that is comprised of a left bar 2120 and a right bar 2130 and (2) a finger bar 2140 that is connected to either bar of the frame 2110 by means of an upper plate 2150 and a lower plate 2160 as well as an axis 2170.

One face of the finger bar 2140 is positioned toward the center of the gate. Another face of the finger bar 2140 is positioned toward the frame's bar and engaged to the lower plate 2160 by means of a rounded toothed rack 2180. The rack is mechanically engaged with the lower plate 2160 by a lower plate protrusion 2190. In one embodiment, the gate comprises single horizontal finger bar 2140. In another embodiment, the gate comprises a plurality of the horizontal finger bars 2140. In another embodiment, the finger bars 2140 are located on a single bar of the frame 2110. In another embodiment, finger bars 2140 are placed on both bars. In one embodiment, the finger bars are of a same length. In another embodiment, the finger bars have different lengths. In one embodiment, the distance between the finger bars is the same along the frame of the gate. In another embodiment, the distance between the different finger bars position may vary. In operation, the livestock animal, enters the gate and pushes the fingers inside the gate opening. The fingers rotate around the axis 2170 opening the gate and enabling the passage through. The motion of each finger bar is independent of motion of other finger bars on the gate. In one embodiment, the motion is driven manually. In another embodiment the motion is driven automatically.

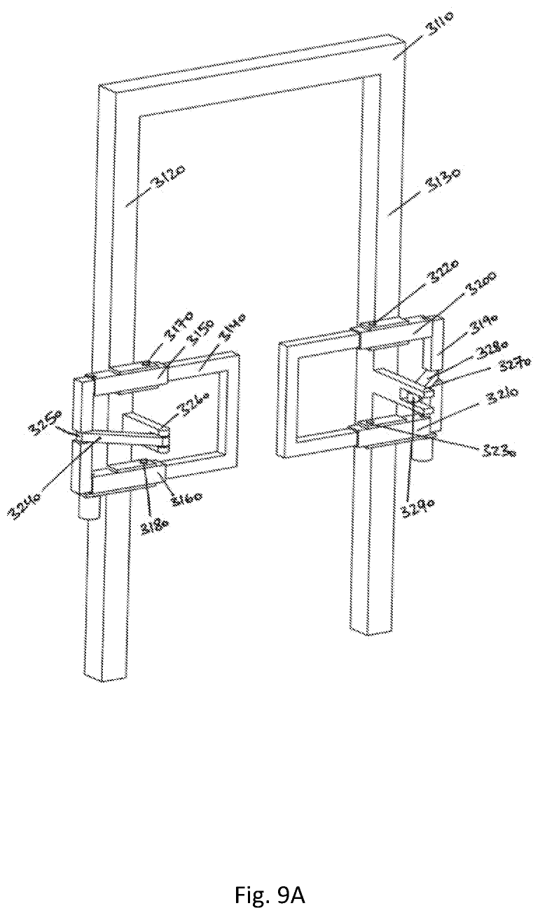

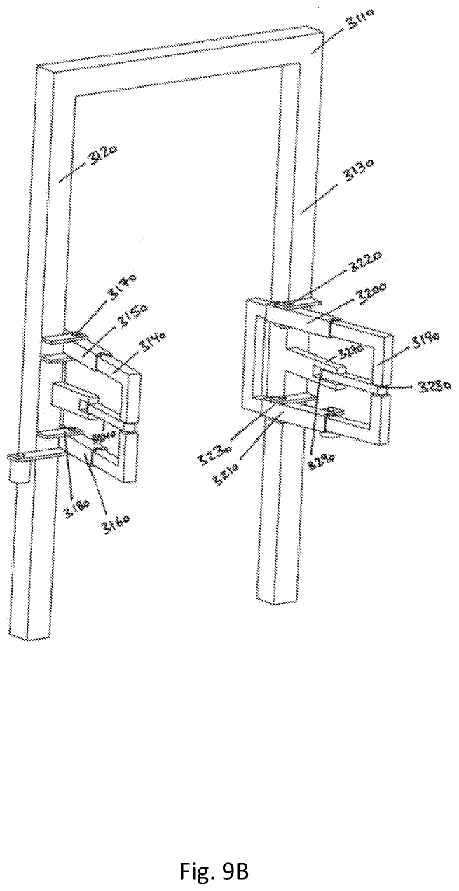

Reference is now made to FIG. 9A-B. FIG. 9 illustrates high level view of a dual axes gate in closed (FIG. 9A) and open (FIG. 9B) state. The dual axes gate comprises: (1) a frame 3110 comprising a left bar 3120 and a right bar 3130; (2) a left closing frame 3140 that is inserted into a left upper profile section 3150 and a left lower profile section 3160 that are connected to the left bar 3120 by upper left axis 3170 and lower left axis 3180, respectively; (3) a right closing frame 3190 that is inserted into a right upper profile section 3200 and a right lower profile section 3210 that are connected to the right bar 3130 by upper right axis 3220 and lower right axis 3230, respectively; (4) a left shaft 3240 that is connected to the left closing frame 3140 by a protruding end of the left bar 3120 of the frame 3110 by first left axis 3250 and second left axis 3260, respectively; and (5) a right shaft 3270 that is connected to the right closing frame 3190 and a protruding end of the right bar 3130 of the frame 3110 by first right axis 3280 and second right axis 3290, respectively. As illustrated in FIG. 9A, in the gate closed state, the left closing frame 3140 and the right closing frame 3190 slide maximally to the center of the frame 3110 closing the gate opening. Operationally, to enable opening, the livestock animal has to push the left closing frame 3140 and the right closing frame 3190 inside the gate opening while rotating the frames by means of rotation of the left upper profile section 3150 with the left lower profile section 3160, as well as the right upper profile section 3200 with the right lower profile section 3210, respectively. The frames rotation with opening the gate becomes possible due to the linear motion of the frames inside the profile sections; these linear motions are enabled by push of both the left shaft 3240 and the right shaft 3270. In one embodiment, reverting the gate from open to closed state by means of the left closing frame 3140 and the right closing frame 3190 is performed manually. In another embodiment the rotation motion of the left closing frame 3140 and the right closing frame 3190 is performed automatically.

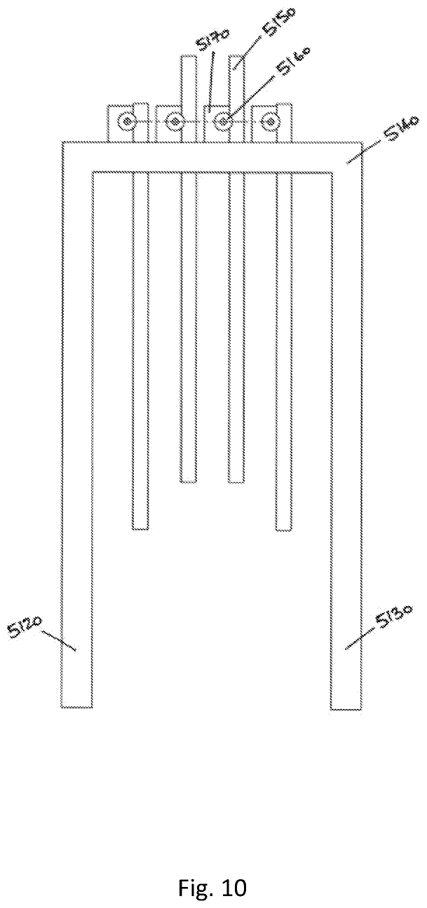

Reference is now made to FIG. 10. FIG. 10 illustrates high level view of a vertical sticks gate. The vertical rod gate comprises: (1) a frame 5110 comprising a left bar 5120, a right bar 5130, and an upper bar 5140; (2) a toothed rack 5150 that slides up and down, being engaged with a gear 5160 attached to the upper bar 5140 by the gear assembly 5170. In one embodiment, the gate comprises a single toothed rack 5150. In another embodiment, the gate comprises a plurality plurality of the toothed racks, while the number of the toothed racks dependents on widths of the gate opening and size of the livestock animal.

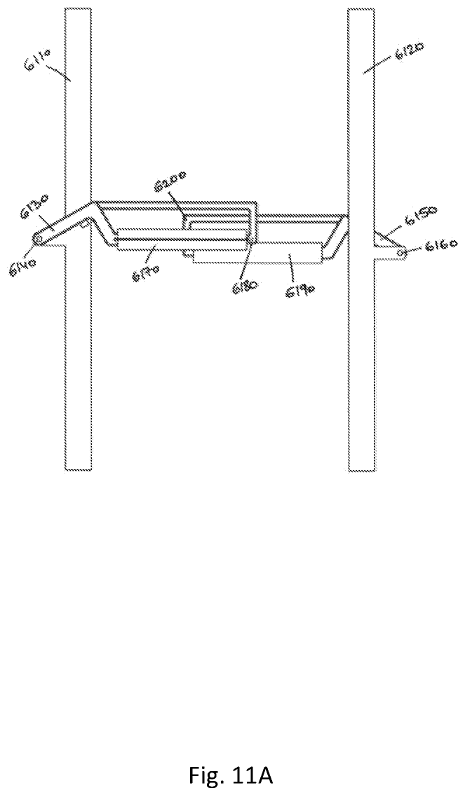

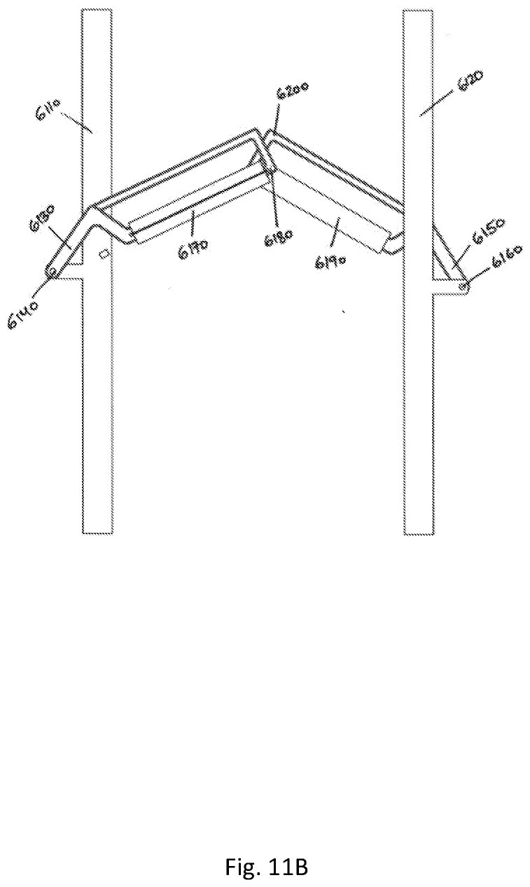

Reference is now made to FIG. 11A-B. FIG. 11 illustrates high level view of a blocking gate in closed (FIG. 11A) and open (FIG. 11B) state. The blocking gate comprises: (1) a frame comprising a left bar 6110 and a right bar 6120; (2) left blocking assembly 6130 that is connected to the left bar 6110 by means of the left rotational axis 6140 that enables rotation of the blocking assembly 6130 from its initial horizontal or blocking position counterclockwise and back to its initial position; (3) right blocking assembly 6150 that is connected to the right bar 6120 by means of the right rotational axis 6160 that enables rotation of the blocking assembly 6150 from its initial horizontal, the blocking position clockwise and back to its initial position; (4) left blocking assembly 6130 contains a left barrel 6170 assembled on a left assembly rod 6180; and (5) right blocking assembly 6150 contains a right barrel 6190 assembled on the right assembly rod 6200. In one embodiment the left blocking assembly 6130 and the right blocking assembly 6150 are connected to the same side of the left bar 6110 and the right bar 6120 of the frame of the gate. In another embodiment the left blocking assembly 6130 and the right blocking assembly 6150 are connected to the opposite sides of the left bar 6110 and the right bar 6120. While the livestock animal passes through the gate, it pushes the left blocking assembly 6130 and the right blocking assembly 6150 upward rotating the both assemblies about the left rotational axis 6140 and the right rotational axis, respectively. With the livestock animal passing the gate, the left barrel 6170 and the right barrel 6190 rotate about the left assembly rod 6180 and the right assembly rod 6200, respectively. After livestock animal passes the gate, the left blocking assembly 6130 and the right blocking assembly 6150 return to their initial position under the gravitation forces. In one embodiment, the left blocking assembly 6130 and the right blocking assembly 6150 are kept in their initial, closed state, due to gravitational forces. In another embodiment, left blocking assembly 6130 and he right blocking assembly 6150 are kept in the closed state by applying an electrical drive that locks the assemblies motion up by the livestock animal when not allowed.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof. As used herein the terms “comprises”, “comprising”, “includes”, “including”, “having” and their conjugates mean “including but not limited to”. The term “consisting of” means “including and limited to”.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “operatively coupled” to, “operatively linked” to, “operatively engaged” with, “connected” to, “coupled” with, “contacting,” etc., another element, it can be directly on, attached to, connected to, operatively coupled to, operatively engaged with, coupled with and/or contacting the other element or intervening elements can also be present. In contrast, when an element is referred to as being “directly contacting” another element, there are no intervening elements present.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section.

Certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

Certain features described in the context of various embodiments are not to be considered essential features of those embodiments, unless the embodiment is inoperative without those elements.

Throughout this application, various embodiments of this invention may be presented in a range format. It should be understood that the description in range format is merely for convenience and brevity and should not be construed as an inflexible limitation on the scope of the invention.

Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

All publications, patent applications, patents, and other references mentioned in the disclosures of these publications in their entireties are hereby incorporated by reference into this application in order to more fully describe the state of the art to which this invention pertains. In case of conflict, the patent specification, including definitions, will prevail. In addition, the materials, methods, and examples are illustrative only and not intended to be limiting. Throughout this application various publications, published patent applications and published patents are referenced.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein.

1. A system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller.

2. The system of claim 1, wherein the controller is configured to receive instructions from the computer, and to exercise actions according to the instructions, wherein the actions are selected from: signaling the livestock animal to the gate; changing the state of the gate from the locked state to the unlocked state; changing the state of the gate from the unlocked state to the locked state; maintaining the gate in an unlocked and/or locked state for a predetermined time interval; activating the signaling unit; inactivating the signaling unit; activating the animal identification unit; and, inactivating the animal identification unit.

3. The system of claim 2, wherein the controller is at least one of the following: (a) configured to maintain the gate at the unlocked state for a predetermined time interval, wherein said predetermined time interval is sufficient to allow passage of a single livestock animal through the gate (b) configured to repeatedly change the state of the gate from the locked state to the unlocked state, and, to maintain the gate at the unlocked state for the predetermined time interval, wherein said predetermined time interval is sufficient to allow passage of a single livestock animal through the gate, or (c) configured to maintain the gate at the unlocked state for the predetermined time interval, wherein said predetermined time interval is sufficient to allow passage of a predetermined number of livestock animals through the gate.

4. (canceled)

5. (canceled)

6. The system of claim 1, wherein the gate mechanism is configured to at least one of: (a) allow passage of livestock animals in unidirectional manner, or (b) allow passage of at least one livestock animal in bi-directional manner.

7. (canceled)

8. The system of claim 1, wherein the opening of the gate is at least one of: (a) in the unlocked state is triggered by the motion of the livestock animal, (b) in the unlocked state is automated.

9. (canceled)

10. The system of claim 8, wherein the gate opening is triggered by livestock animal identification data acquired by the animal identification unit.

11. The system of claim 1, comprising at least two gates and/or wherein the system is configured to allow passage of multiple livestock animals, and/or wherein the signaling element is configured to generate a plurality of signals.

12. (canceled)

13. (canceled)

14. The system of claim 11, wherein the controller is at least one of: (a) configured to change the state of each of the gates independently of each other, or (b) operates the signaling element to signal the livestock animal to approach a one, but not the other gate.

15. (canceled)

16. (canceled)

17. The system of claim 14, wherein the signal is at least one of: (a) different for each gate, (b) identical for all gates, (c) identical for each livestock animal, (d) different for each livestock animal.

18. (canceled)

19. (canceled)

20. (canceled)

21. The system of claim 1, comprising at least one of: (a) more than one signaling element, (b) more than one controller, or (c) the gate is situated at the opening of an enclosed area where the at least one livestock animal resides.

22. (canceled)

23. (canceled)

24. (canceled)

25. The system of claim 1, wherein at least one of the following holds true: (a) the system is designed to serve as a sorting gate, (b) the animal identification unit is an image acquisition sensor or data reader, (c) the system further comprising animal activity identification unit in communication with the controller, (d) wherein the at least one livestock animal is trained to recognize the signal generated by the at least one signaling element, or (e) wherein the livestock animal is selected from beef cattle, dairy cattle, sheep, goats, horses, and pigs.

26. (canceled)

27. (canceled)

28. The system of claim 25, wherein the animal activity identification unit is configured to collect data related to the activity of an individual livestock animal.

29. The system of claim 28, wherein the data related to the activity of the individual livestock animal are related to feeding behavior of said livestock animal.

30. The system of claim 29, wherein the data related to food behavior are selected from: food intake; feeding time; body weight prior to feeding; body weight after feeding; type of food; or a combination thereof.

31. (canceled)

32. The system of claim 25, wherein the at least one livestock animal is trained to recognize the signal generated by the at least one signaling element and to approach the gate.

33. (canceled)

34. A method for directing livestock comprising:
a. providing a system for directing livestock, the system comprising: a) at least one gate equipped with a gate mechanism, the gate having a locked state and an unlocked state, configured to allow passage of at least one livestock animal when in unlocked state; b) at least one signaling element configured to signal the livestock animal; c) at least one animal identification unit configured to identify the livestock animal; d) at least one controller in communication with the gate, the signaling element and the animal identification unit; and e) at least one computer in communication with the controller;
b. providing instructions by the computer to the controller to direct the livestock;
c. activating the signaling element;
d. signaling at least one livestock animal to approach the gate;
e. changing the state of the gate from the locked state to the unlocked state;
f. allowing passage of the at least one livestock element through the gate; and
g. changing the state of the gate to locked state.

35. The method of claim 34, (a) further comprising the step of identification of the at least one livestock animal by the animal identification unit, and/or (b) the system comprises multiple gates, and/or (c) the livestock animal is selected from beef cattle, dairy cattle, sheep, goats, horses, and pigs.

36. (canceled)

37. (canceled)

38. A system for directing livestock comprising: a) at least one gate equipped with a gate mechanism, the gate having a locked state and an unlocked state, configured to allow passage of at least one livestock animal when in unlocked state; b) at least one signaling element configured to signal the livestock animal; c) at least one controller in communication with the gate and the signaling element; and e) at least one computer in communication with the controller.

39. The system of claim 38, wherein the controller is configured to receive instructions from the computer, and to exercise actions according to the instructions, wherein the actions are selected from: signaling the livestock animal to the gate; changing the state of the gate from the locked state to the unlocked state; changing the state of the gate from the unlocked state to the locked state; maintaining the gate in an unlocked and/or locked state for a predetermined time interval; activating the signaling unit; and, inactivating the signaling unit and/or further comprising animal identification unit in communication with the controller.

40. (canceled)

41. The system of claim 39, wherein the controller is further configured to activate the animal identification unit; and, to inactivate the animal identification unit.
